(19) United States
(12) Patent Application Publication
(10) Pub. No.: US 2010/0316929 A1
(43) Pub. Date: Dec. 16, 2010

(54) AQUEOUS FORMULATIONS COMPRISING POLYAROMATIC COMPOUNDS BEARING ACID GROUPS AND/OR SALTS OF ACID GROUPS, PROCESS FOR PRODUCING THEM, FURTHER FORMULATIONS PRODUCED USING THE AQUEOUS FORMULATIONS AND USE OF THE FURTHER FORMULATIONS IN FUEL CELLS

(75) Inventors: Guenter Oetter, Frankenthal (DE); Ria Kress, Ludwigshafen (DE); Dennis Loesch, Altrip (DE); Alexander Khvorost, Laudenbach (DE); Gerhard Eugen Wahsner, Ludwigshafen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/521,681

(22) PCT Filed: Dec. 6, 2007
(86) PCT No.: PCT/EP2007/063406

§ 371 Date: Jun. 29, 2009

(30) Foreign Application Priority Data
Dec. 28, 2006 (EP) 06127261.3

(51) Int. Cl. H01M 8/10; C08J 5/22

(52) U.S. Cl. 429/480; 521/27; 429/492

(57) ABSTRACT

Process for producing aqueous formulations (A) comprising at least one polyaromatic compound bearing acid groups and/or salts of acid groups and also aqueous formulations (A) which have been produced according to the process of the invention. Also a process for producing dried formulations (B) by removing the water from the aqueous formulations (A) and also the dried formulations (B) themselves. In addition a formulation (C) comprising the dried formulation (B) of the invention and also water or an aqueous formulation (A) and a water-comprising formulation (D) comprising the aqueous formulation (A) of the invention or the formulation (C) of the invention and additionally at least 2% by weight of an organic solvent. Additionally dry formulations (E) which are obtained by removing water from the water-comprising formulations (D) of the invention. Also the use of the water-comprising formulations (D) of the invention and of the dry formulations (E) obtained from these for producing a polymer electrolyte membrane and also the polymer electrolyte membrane itself and a membrane-electrode assembly (MEA) and also a fuel cell comprising the polymer electrolyte membrane of the invention.

Aqueous formulations comprising polyaromatic compounds bearing acid groups and/or salts of acid groups, process for producing them, further formulations produced using the aqueous formulations and use of the further formulations in fuel cells

The present invention relates to a process for producing aqueous formulations (A) comprising at least one polyaromatic compound bearing acid groups and/or salts of acid groups, in particular sulfonated polyaromatic compound, and also aqueous formulations (A) which have been produced according to the process of the invention. The present invention further relates to a process for producing dried formulations (B) by removing the water from the aqueous formulations (A) and also the dried formulations (B) themselves. Furthermore, the present invention relates to a formulation (C) comprising the dried formulation (B) of the invention and also water or an aqueous formulation (A) and a water-comprising formulation (D) comprising the aqueous formulation (A) of the invention or the formulation (C) of the invention and additionally at least 2% by weight of an organic solvent. The present invention further relates to dry formulations (E) which are obtained by removing water from the water-comprising formulations (D) of the invention. The present invention additionally provides for the use of the water-comprising formulations (D) of the invention and of the dry formulations (E) obtained from these for producing a polymer electrolyte membrane and also the polymer electrolyte membrane itself and a membrane-electrode assembly (MEA) and also a fuel cell comprising the polymer electrolyte membrane of the invention.

Functionalized, in particular sulfonated, polyaromatic compounds and their use are known in the prior art. For example, functionalized polyaromatic compounds are used as or in polymer electrolyte membranes in fuel cell technology. Furthermore, sulfonated polyaromatic compounds can be used in electrolytic cells, for example chloralkali cells, and in or as catalysts for numerous chemical reactions and in processes such as reverse osmosis or ultrafiltration.

Polymer electrolyte membranes produced from the polyaromatic compounds bearing acid groups, in particular sulfonated polyaromatic compounds, are generally produced by dissolution of the polyaromatic compounds bearing acid groups in an organic solvent such as DMAc (N,N-dimethylacetamide), DMF (dimethylformamide), DMSO (dimethyl sulfoxide) or NMP (N-methylpyrrolidone) and subsequent precipitation or removal of the solvent.

A disadvantage is that the solvents mentioned are expensive and have high boiling points, so that their removal is difficult. To reduce costs, to protect the environment and for occupational hygiene reasons, it would therefore be desirable to make processing of the polyaromatic compounds bearing acid groups in aqueous solutions possible. A further reason is that, especially in the production of noble metal catalyst materials, the use of heteroatom-comprising, in particular chlorine-, sulfur- and nitrogen-comprising, solvents should be avoided or minimized since these can act as catalyst poisons. For this reason, aqueous formulations of polyaromatic compounds bearing acid groups, for example, are of interest for producing gas diffusion electrodes for fuel cells or electrolysis units or for producing membrane-electrode assemblies (MEA) for fuel cells.

A problem in the production of aqueous formulations of polyaromatic compounds bearing acid groups is their solubility, in particular when polyaromatic compounds bearing acid groups which have a low or moderate number of acid groups are used, since such polyaromatic compounds bearing acid groups are particularly sparingly soluble in water or water-comprising solvents.

WO 2005/068542 relates to polymer solutions comprising a sulfonated polyaryl ether ketone or polyaryl ether sulfone which is not directly water-soluble at a temperature up to 100° C. The solvent in these solutions is at least 90% water. The polymer solutions can be used for producing electrocatalyst inks and electrocatalyst layers for use in fuel cells. According to WO 2005/068542, the polymer solutions are produced by dissolution of the sulfonated polymer in a first solvent having a boiling point lower than that of water, addition of water and subsequent removal of the first solvent, which surprisingly does not result in the polymer precipitating but instead forms kinetically stable aqueous solutions. According to the description in WO 2005/068542, the solutions have solids contents of from >1 to <10% by weight.

WO 98/55534 discloses a process for producing aqueous, water-comprising and nonaqueous solutions of polymers functionalized with acid groups, in which the heat necessary for producing the solution is introduced by means of microwave radiation. The solutions serve as starting material for the production of gas diffusion electrodes, fuel cells and polymer electrolyte-stabilized platinum nanoparticles. The polymers functionalized with acid groups are, for example, sulfonated polyether ketones (PEK), polyether ether ketones (PEEK) and polyether ether ketone ketones (PEEKK). According to comparative example 3 in WO 98/55534, an attempt is made to dissolve sulfonated PEEKK in water at 165° C. and an internal pressure of 3.5 bar without microwave irradiation. This gives a brownish gel. The supernatant solution comprises about 5% by weight of the sPEEKK.

Since irradiation with microwaves is complicated and an appropriate apparatus for irradiation is not available everywhere, it is desirable to provide aqueous and water-comprising formulations of polyaromatic compounds bearing acid groups without microwave irradiation being necessary. It is desirable for the aqueous and water-comprising formulations to have a very high solids content (content of polyaromatic compounds bearing acid groups).

This object is achieved by a process for producing a formulation comprising at least one polyaromatic compound bearing acid groups and/or salts of acid groups, which comprises the step (i):
(i) treatment of a mixture comprising at least one polyaromatic compound bearing acid groups and/or salts of acid groups and water at a temperature of >170° C., preferably from 171 to 350° C., particularly preferably from 180 to 250° C., in a closed reactor to give an aqueous formulation A.

The process of the invention makes it possible to obtain aqueous formulations A of polyaromatic compounds bearing acid groups and/or salts of acid groups which have high solids contents. The aqueous formulations A are generally solutions or dispersions of at least one polyaromatic compound bearing acid groups and/or salts of acid groups.

For the purposes of the present patent application, the expression “water” refers to water, preferably mains water, comprising the amounts of impurities which are usual for mains water. It is likewise possible, for example, to use partially or fully deionized water. The addition of further components such as salts and emulsifiers is possible but is not carried out in a preferred embodiment of the process of the invention.

For the purposes of the present patent application, the expression “acid groups” preferably refers to sulfonic acid, phosphoric acid, carboxylic and/or boric acid groups, with sulfonic acid groups being particularly preferred. “Salts of acid groups” are preferably the salts of the abovementioned acid groups. Suitable salts are the salts of monovalent and polyvalent cations. Examples of suitable polyvalent cations are Al³⁺, Mg²⁺ and Ca²⁺. Particular preference is given to salts having monovalent cations, particularly preferably monovalent cations selected from the group consisting of Li⁺, Na⁺, K⁺, Rb⁺, Cs⁺, NH₄⁺ and mixtures thereof.

The proportion of acid groups and/or salts of acid groups in the polyaromatic compounds is generally from 0.5 to 2 mmol of acid groups and/or salts of acid groups per g of polyaromatic compound (ion exchange capacity, IEC, calculated back from elemental analysis), preferably from 1 to 1.8 mmol of acid groups and/or salts of acid groups per g of polyaromatic compound. The IEC indicates the number of mmol of acid groups (and/or salts thereof) which are available per gram of polymer.

The polyaromatic compounds bearing acid groups and/or salts of acid groups comprised in the formulation A produced according to the invention and the polyaromatic compounds bearing acid groups and/or salts of acid groups used to produce the formulation A can be either polyaromatic compounds bearing exclusively acid groups or polyaromatic compounds bearing exclusively salts of acid groups. Polyaromatic compounds which bear both acid groups and salts of acid groups are likewise comprised by the expression “polyaromatic compound bearing acid groups and/or salts of acid groups”. The ratio of acid groups to salts of acid groups in the polyaromatic compounds is generally from 100:1 to 1:100, preferably from 50:1 to 1:50.

Furthermore, mixtures of polyaromatic compounds bearing exclusively acid groups and/or polyaromatic compounds bearing exclusively salts of acid groups and/or polyaromatic compounds bearing both acid groups and salts of acid groups can be used in the process of the invention.

For the purposes of the present patent application, the expression “polyaromatic compound” refers to a polymer which has a plurality of arylene groups within the polymer chain, preferably a plurality of phenylene groups. Suitable “polyaromatic compounds” are disclosed, for example, in US 2002/0091225, WO 2005/049696, WO 2005/050671, JP2004-345997, US 2004/0149965, EP-A-1 479 714 and EP-A 1 465 277.

The expression “polyaromatic compound” preferably refers to a compound selected from the group consisting of polyethers, polyketones, polyaryl ether ketones, polythioether ketones, polyaryl sulfones, polyether sulfones, polythioether sulfones, polyphenylene sulfides, polysulfones. The “polyaromatic compound” is particularly preferably selected from among polyaryl ether ketones, polyaryl sulfones, polyether sulfones, polyphenylene sulfides and polysulfones. Very particular preference is given to polyaryl ether ketones. It is possible to use one or more different polyaromatic compounds in the process of the invention. Here, the polyaromatic compounds can differ in terms of their basic structure, their molecular weight and/or their proportion of salts of acid groups or other parameters.

In a particularly preferred embodiment, the polyaromatic compounds bearing acid groups and/or salts of acid groups which are present in the formulations A and those used in step (i) are selected from among polyaryl ether ketones, polyaryl sulfones, polyether sulfones, polyphenylene sulfides and polysulfones bearing sulfonic acid, phosphoric acid, carboxyl, boric acid groups and/or salts thereof.

The polyaromatic compounds can bear the acid groups on their aromatic rings or on side chains. The side chains are, for example, aryl, alkyl, alkylaryl, arylalkyl, alkenylaryl, arylalkenyl or alkenyl groups which are substituted by the acid groups and/or salts of acid groups. The side chains can be joined to any atom of the main polymer chain. They are preferably joined to the aromatic rings of the polyaromatic compounds. Suitable examples are:

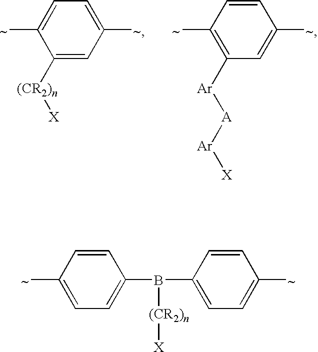

where
X=acid group and/or salt of the acid group
A=CR₂, NR, S, O
B=CR, N
R=substituted or unsubstituted alkyl or substituted or unsubstituted aryl
n=0 to 10.

The examples serve exclusively for the purposes of illustration. A person skilled in the art will know that numerous further ways of linking the acid groups and/or salts of acid groups to the polyaromatic compounds are possible and these are comprised by the disclosure of the present patent application.

The polyaromatic compounds bearing acid groups are prepared by methods known to those skilled in the art. Suitable processes are disclosed, for example, in US 2002/0091225, WO 2005/049696, WO 2005/050671, JP 2004-345997 A, US 2004/0149965, EP-A 1 479 714 and EP-A 1 465 277. The partial or complete conversion of the acid groups present in the polyaromatic compounds into the corresponding salts is carried out by methods known to those skilled in the art, e.g. by treatment of the polyaromatic compounds comprising acid groups with suitable, preferably aqueous, solutions of the desired salts. Any aqueous solutions of the desired salts are suitable here. Examples of suitable solutions are the hydroxide solutions, the carbonate solutions and the halide solutions of the desired salts. Preferred cations of the salts have been mentioned above.

The polyaromatic compounds bearing acid groups are particularly preferably sulfonated polyaryl ether ketones.

All known sulfonated polyaryl ether ketones are suitable as sulfonated polyaryl ether ketones. These are generally obtained by sulfonation of the corresponding polyaryl ether ketones. Suitable sulfonation processes are known to those skilled in the art and are disclosed, inter alia, in EP-A 0 008 895, WO 03/03198, DE-A 3402471, DE-A 3321860, EP-A 0 574 791, EP-A 815 159 and WO 2004/076530. The polyaryl ether ketones are commercially available or can be prepared by methods known to those skilled in the art. The partial or complete conversion of the acid groups into the corresponding salts is carried out, as mentioned above, by methods known to those skilled in the art.

The sulfonated polyaryl ether ketones are preferably selected from the group consisting of sulfonated polyether ketones (sPEK), sulfonated polyether ether ketones (sPEEK), sulfonated polyether ketone ketones (sPEKK) and sulfonated polyether ether ketone ketones (sPEEKK).

For the purposes of the present patent application, the term “sulfonated” encompasses both polyaryl ether ketones bearing free sulfonic acid groups and polyaryl ether ketones bearing salts of the sulfonic acid groups and also polyaryl ether ketones bearing both salts and free sulfonic acid groups.

The degree of sulfonation of the sulfonated polyaryl ether ketones used according to the invention is generally from 10 to 90%, preferably from 20 to 80%, particularly preferably from 30 to 60%, very particularly preferably from 35 to 55%. Suitable processes for preparing sulfonated polyaryl ether ketones having the stated degrees of sulfonation are mentioned in the documents cited above. The degree of sulfonation indicates the number of acid functions (and/or the corresponding salts) per repeating unit of the polymer in % (mol %).

In the process of the invention, preference is given to producing formulations which comprise from 1 to 5 polyaromatic compounds bearing acid groups and/or salts of acid groups, preferably 1 or 2 polyaromatic compounds bearing acid groups and/or salts of acid groups, particularly preferably 1 polyaromatic compound bearing acid groups and/or salts of acid groups.

Apart from the at least one polyaromatic compound bearing acid groups and/or salts of acid groups, the formulations of the present patent application can comprise further polymeric compounds, in particular polymeric compounds bearing acid groups, which are not aromatic, e.g. sulfonated fluoropolymers such as Nafion®, Aciplex®, Flemion® and/or Hyflon Ion®. It is possible, for example, for the formulations A to be produced by joint dissolution of the at least one polyaromatic compound bearing acid groups and/or salts of acid groups together with the further polymeric compound in step i).
Step i) Contacting of the at Least one Polyaromatic Compound Bearing Acid Groups and/or salts of Acid Groups with Water

To produce aqueous formulations A comprising at least one polyaromatic compound bearing acid groups and/or salts of acid groups, the at least one polyaromatic compound bearing acid groups and/or salts of acid groups is, according to the process of the invention, brought into contact with water.

Step i) is carried out at a temperature of >170° C., preferably from 171 to 350° C., particularly preferably from 180 to 250° C. If temperatures higher than those mentioned are employed, decomposition of the polyaromatic compounds bearing acid groups and/or salts of acid groups occurs. At temperatures lower than those mentioned, the polyaromatic compounds bearing acid groups and/or salts of acid groups do not go into solution or go into solution only to a slight extent. The precise decomposition temperature depends on the polyaromatic compound bearing acid groups and/or salts of acid groups which is used.

In a preferred embodiment, the temperature in the treatment in step i) is kept constant. Here, the term “constant” means a temperature deviation of +/−2° C. This gives good reproducibility of the solids contents obtained and the later casting solution.

Step i) is carried out in a closed reactor which is pressure resistant. Suitable reactors are known to those skilled in the art. For example, step (i) is carried out in an autoclave. Thus, step (i) is generally carried out at a pressure which corresponds to at least the autogenous pressure at the temperatures mentioned. However, it is likewise possible to release the pressure in a controlled fashion during the treatment in step (i) and carry out the treatment at a pressure which is lower than the autogenous pressure.

To obtain very high solids contents of the formulations A, the process of the invention is usually carried out by admixing the at least one polyaromatic compound comprising acid groups and/or salts thereof which is used in step (i) with water and treating it at the abovementioned temperatures in a closed reactor. This generally gives an aqueous formulation A together with a gel-like solid which comprises polyaromatic compounds bearing acid groups and/or salts thereof which have not gone into solution. To obtain the aqueous formulation A, the gel-like solid is generally separated off by means of methods known to those skilled in the art, e.g. by centrifugation, decantation, filtration, etc.

The process of the invention gives aqueous formulations A in which the at least one polyaromatic compound bearing acid groups and/or salts of acid groups is present in dissolved or dispersed form. According to analysis by means of gel permeation chromatography (eluent: DMAc (+LiBr), detector: differential refractometer ERC7515A), the polyaromatic compound bearing acid groups and/or salts thereof is present in unchanged form, i.e. no change in the molecular weight of the polyaromatic compound bearing acid groups and/or salts of acid groups has occurred.

The improved water solubility of the polyaromatic compounds bearing acid groups and/or salts of acid groups, which is surprising in view of the water solubility of polyaromatic compounds bearing acid groups according to the prior art, is due to an altered particle morphology of the polyaromatic compounds bearing acid groups and/or salts thereof brought about by the treatment according to the invention of the polyaromatic compounds bearing acid groups and/or salts of acid groups. The polyaromatic compounds bearing acid groups and/or salts thereof which have been treated according to the invention have different physical properties (particle morphology, water solubility) than polyaromatic compounds bearing acid groups according to the prior art which have the same content of acid groups. The alteration of the particle morphology of the polyaromatic compounds bearing acid groups and/or salts thereof which is effected in the process of the invention occurs only above a particular temperature and a particular pressure. The change in the particle morphology leads to an improved “water solubility”. Below this temperature, an improved water solubility of the polyaromatic compound bearing sulfonic acid groups and/or salts thereof cannot be achieved. This is made clear, for example, in comparative example 3 disclosed in WO 98/55534. The temperature selected in this comparative example (165° C.) is not sufficient to achieve an altered particle morphology and thus an improved water solubility of the polyaromatic compound bearing acid groups which is used.

In a preferred embodiment of the present invention, polyaromatic compounds bearing salts of acid groups are used in the process of the invention. Here, all acid groups of the respective polyaromatic compounds can be present in their salt form or only part of the acid groups can be present in salt form so that the polyaromatic compounds bear both acid groups and salts of acid groups. Preferred ratios of acid groups to salts of acid groups and also preferred salts have been mentioned above.

It has been found that when polyaromatic compounds bearing salts of acid groups are used, numerous advantageous over the use of polyaromatic compounds bearing exclusively free acid groups are achieved:
a) a reduction in the gel-like solid (residue) which is generally formed in step (i) and thus an increase in the yield of dissolved or dispersed polyaromatic compound bearing salts of acid groups, resulting in a reduction in the outlay for cleaning the reactor due to the reduced quantity of gel;
b) the more complete dissolution or dispersion makes the work-up of the polymer solution easier, since it generally only has to be filtered and the previously preferred centrifugation is not necessary;
c) the polyaromatic compounds bearing salts of acid groups can be treated in step (i) at higher solids contents than the H Form (=polyaromatic compounds bearing free acid groups), i.e. the throughput in step (i) can be increased;
d) due to the higher solids content of the aqueous formulation A, less water has to be evaporated during subsequent drying (see process step ii), formulation B), i.e. the process is more energy-efficient;
e) polyaromatic compounds bearing salts of acid groups which have been treated according to step (i) of the process of the invention result, at the same viscosity, in a higher solids content in the finished casting solution (see formulation D), which makes membrane production significantly more efficient;
f) the use of polyaromatic compounds which bear salts of acid groups and have no free hydrogen atoms greatly reduces the corrosiveness. Instead of an enamel reactor which is generally required when working with free acids, in particular sulfonic acids, it is possible to use a metal reactor for carrying out the process of the invention when polyaromatic compounds bearing salts of acid groups, in particular of sulfonic acids, are used.

An embodiment of the process of the invention therefore relates to the use of polyaromatic compounds bearing salts of acid groups in a metal reactor. Suitable compounds bearing salts of acid groups have been mentioned above. Suitable metal reactors, e.g. metal autoclaves, are known to those skilled in the art. The metal of the metal reactor is generally high-alloy steel.

In a further preferred embodiment of the present invention, the process of the invention is carried out using a mixture which comprises not only the at least one compound bearing acid groups and/or salts of acid groups and water but also from 0.1 to 5% by weight, preferably from 0.1 to 2% by weight, particularly preferably from 0.5 to 1% by weight, based on the total amount of the mixture, of at least one polar aprotic solvent, preferably selected from the group consisting of N-methyl-2-pyrrolidone, N,N-dimethylacetamide, dimethylformamide, dimethyl sulfoxide, tetrahydrofuran, acetonitrile, methylene chloride, chloroform, EtOAc and mixtures thereof, particularly preferably N-methyl-2-pyrrolidone. It has been found that the solids content, i.e. the content of polyaromatic compounds bearing acid groups and/or salts of acid groups, in the casting solution (see formulation D described below) can be increased further when small amounts of one or more polar aprotic solvents are added to the mixture used in the process of the invention. The amounts of polar aprotic solvent are so small that their own dissolution capability is not sufficient to dissolve polyaromatic compounds bearing acid groups and/or salts thereof which have not been treated according to the invention. When more than the claimed amount of a polar aprotic solvent is added, the “water solubility” deteriorates.

The solids content of the final casting solution (formulation D) can thus be increased further by the addition according to the invention of small amounts of polar aprotic solvent. The advantage (e) mentioned above in relation to the use of salts of acid groups of polyaromatic compounds is likewise achieved in this way. It is likewise possible to achieve particularly high solids contents of the casting solution (formulation D) by a combination of the use of the polyaromatic compounds bearing salts of acid groups with the addition of the polar aprotic solvent.

In a further embodiment of the present invention, the at least one polyaromatic compound bearing acid groups and/or salts of acid groups which is used in step (i) of the process of the invention has a residual moisture content of ≧30% by weight, preferably ≧50% by weight, particularly preferably ≧70% by weight. The at least one polyaromatic compound bearing acid groups and/or salts of acid groups which is used in step (i) particularly preferably does not have a residual moisture content of less than 30% by weight, preferably less than 50% by weight, particularly preferably less than 70% by weight, at any point of time during its preparation. The use according to the invention of at least one polyaromatic compound bearing acid groups and/or salts of acid groups which has a residual moisture content as set forth above enables the solids content of the formulation A and of the final casting solution to be increased. Furthermore, the proportion of gel-like solid formed in the production of the formulation A is generally decreased. The advantages (a) to (d) mentioned above in relation to the use of salts of acid groups of polyaromatic compounds and in relation to the addition of an additional polar aprotic solvent are likewise achieved in this way. It is also possible to combine the abovementioned embodiments in any way in order to achieve particularly high solids contents.

When polyaromatic compounds bearing acid groups and/or salts of acid groups which have a residual moisture content as indicated above are used, the step of drying before use in step (i) of the process of the invention becomes unnecessary, as a result of which the total process is very energy-efficient.

The expression “at least one polyaromatic compound bearing acid groups and/or salts of acid groups which has a residual moisture content of ≧30% by weight, preferably ≧50% by weight, particularly preferably ≧70% by weight” refers to a composition comprising the at least one polyaromatic compound and water and having a solids content of ≦70% by weight and a water content of ≧30% by weight, preferably a solids content of ≦50% by weight and a water content of ≧50% by weight, particularly preferably having a solids content of ≦30% by weight and a water content of ≧70% by weight, with the sum of solids content and water content being 100% by weight. Particular preference is given to solids contents of from 10 to 70% by weight, particularly preferably from 15 to 50% by weight, very particularly preferably from 20 to 30% by weight, and water contents of from 30 to 90% by weight, particularly preferably from 50 to 85% by weight, very particularly preferably from 70 to 80% by weight, with the sum of solids content and water content being 100% by weight.

The polyaromatic compounds comprising acid groups and/or salts of acid groups which have the residual moisture contents mentioned are obtained by processes known to those skilled in the art in which no drying of the polyaromatic compounds prepared is carried out. As mentioned above, the polyaromatic compounds preferably do not have a residual moisture content below the values indicated above at any point in time.

The high solids contents achieved, in particular, by means of the preferred embodiments of the process of the invention (step (i)) not only result in a reduction in the amount of gel-like solid formed as residue but also have an influence on the viscosity of the casting solution used for producing polymer membranes. The higher the solids content of the formulations A obtained in step (i), the higher the viscosity of the casting solution at a given solids content of the casting solution.

The casting solutions obtained from polyaromatic compounds bearing acid groups and/or salts thereof which have been treated according to the invention (as per step (i)) have excellent stability. In general, they are stable for a number of weeks at temperatures of <35° C.

The aqueous formulation A obtained in step (i) of the process of the invention has a high content of the at least one polyaromatic compound bearing acid groups and/or salts of acid groups. This is generally from 1 to 30% by weight, preferably from 5 to 25% by weight, particularly preferably from 10 to 20% by weight, very particularly preferably from 15 to 20% by weight, with the sum of the at least one polyaromatic compound bearing acid groups and/or salts thereof and water being 100% by weight. The at least one polyaromatic compound bearing acid groups and/or salts thereof is present in the aqueous formulation A in dissolved or dispersed form. The process of the invention thus makes it possible to achieve higher solids contents than has hitherto been possible by means of processes according to the prior art.

In addition, in one embodiment of the present invention, the aqueous formulation obtained in step (i) of the process of the invention can comprise from 0.1 to 5% by weight, preferably from 0.1 to 2% by weight, particularly preferably from 0.5 to 1% by weight, of at least one polar aprotic solvent selected from the group consisting of N-methyl-2-pyrrolidone, N,N-dimethylacetamide, dimethylformamide, dimethyl sulfoxide, tetrahydrofuran, acetonitrile, methylene chloride, chloroform, EtOAc and mixtures thereof, preferably N-methyl-2-pyrrolidone, with the sum of the at least one polyaromatic compound bearing acid groups and/or salts thereof, water and the at least one polar aprotic solvent being 100% by weight.

The present invention thus further provides aqueous formulations A produced by the process of the invention, which preferably comprise the following components
(Aa) from 1 to 30% by weight, preferably from 5 to 25% by weight, particularly preferably from 10 to 20% by weight, very particularly preferably from 15 to 20% by weight, of at least one polyaromatic compound bearing acid groups,
(Ab) from 70 to 99% by weight, preferably from 75 to 95% by weight, particularly preferably from 80 to 90% by weight, very particularly preferably from 80 to 85% by weight, of water and
(Ac) if appropriate, additionally from 0.1 to 5% by weight, preferably from 0.1 to 2% by weight, particularly preferably from 0.5 to 1% by weight, of at least one polar aprotic solvent selected from the group consisting of N-methyl-2-pyrrolidone, dimethylformamide, N,N-dimethylacetamide, dimethyl sulfoxide, tetrahydrofuran, acetonitrile, methylene chloride, chloroform, EtOAc and mixtures thereof, preferably N-methyl-2-pyrrolidone,
   with the sum of the at least one polyaromatic compound bearing acid groups, water and the at least one polar aprotic solvent which may be present if appropriate being 100% by weight.

The aqueous formulation A of the invention, which generally has a content of polyaromatic compounds bearing acid groups and/or salts thereof of from 1 to 30% by weight, has a significantly lower viscosity than formulations of sulfonated polyaryl ether ketones having the same amount of sulfonated polyaryl ether ketone in organic solvents such as DMSO (dimethyl sulfoxide), DMAc (N,N-dimethylacetamide), DMF (dimethylformamide) or NMP (N-methylpyrrolidone). Furthermore, the aqueous formulations A of the present invention have the advantage over organic formulations that water has a lower boiling point than the organic solvents mentioned and is also nontoxic. Furthermore, stable casting solutions can be produced from the aqueous formulations A.

The aqueous formulations obtained in step i) can subsequently be treated further in step (ii).
Step ii) Removal of the Water

In a further step, step ii), the water can be removed from the formulation A obtained in step i). This gives a dried formulation B.

The removal of the water from the aqueous formulations can be effected by means of any method known to those skilled in the art. For example, the water can be removed by applying a vacuum and, if appropriate, heating or by spray drying.

In step (ii) of the process of the invention, the at least one polar aprotic solvent which may, if appropriate, additionally be present in the formulations A of the invention can

(a) be removed completely with the removal of the water,
(b) be partly removed with the removal of the water,
(c) not be removed at all.

This means that the dried formulation B obtained in step (ii) of the process of the invention can

(a) comprise no polar aprotic solvent,
(b) comprise proportions of polar aprotic solvent which are lower than the proportions in the corresponding aqueous formulation A (based on the solids content),
(c) comprise about the same proportions of polar aprotic solvent as the corresponding aqueous formulation A (based on the solids content).

The water can likewise be removed completely or partly in step (ii) of the process of the invention. In general, the removal of the water in step (ii) is carried out to a solids content of the dried formulation B of >90% by weight, preferably >99% by weight.

The dried formulation B obtained in step ii), which comprises the at least one polyaromatic compound bearing acid groups and/or salts of acid groups, is very readily soluble in water, even at room temperature. This is surprising since the polyaromatic compounds bearing acid groups and/or salts of acid groups which are used in step i) are generally insoluble in water. According to analysis by means of gel permeation chromatography, a change in the molecular weights of the polyaromatic compounds bearing acid groups and/or salts thereof has not occurred. As mentioned above, a reason for the good water solubility of the dried formulations B could be an altered morphology of the polyaromatic compounds bearing acid groups resulting from the process carried out in step i). This means that the aqueous formulations A comprising at least one polyaromatic compound bearing acid groups which are produced in step i) of the process of the invention and the dried formulations B comprising at least one polyaromatic compound bearing acid groups which are produced by means of steps i) and ii) differ from aqueous or dried formulations comprising at least one polyaromatic compound bearing acid groups which are known in the prior art.

The present invention therefore further provides a dried formulation B produced by the process of the invention comprising the steps i) and ii). Suitable process conditions and preferred components of the formulations have been mentioned above.

The dried formulations B of the invention can be processed further in various ways.

Firstly, it is possible to use the dried formulations B of the invention for producing aqueous formulations C which have an even higher solids content of polyaromatic compounds bearing acid groups and/or salts thereof than the aqueous formulations A obtained in step i) of the process of the invention. This is effected by addition of water or the aqueous formulation A to the dried formulation B of the invention. Dissolution of the dried formulation B of the invention in water or in the aqueous formulation A makes it possible to obtain aqueous formulations which have a content of the at least one polyaromatic compound bearing acid groups and/or salts thereof of up to 50% by weight, based on the sum of the polyaromatic compound bearing acid groups and/or salts thereof, water and any polar aprotic solvent present.

The present invention therefore further provides a formulation C comprising

a) a dried formulation B according to the invention and
b) water or an aqueous formulation A according to the invention.

The abovementioned formulation C of the invention preferably comprises from 1 to 50% by weight, particularly preferably from 5 to 40% by weight, very particularly preferably from 10 to 35% by weight and in particular from 25 to 35% by weight, of the at least one polyaromatic compound bearing acid groups and/or salts thereof, based on the sum of the at least one polyaromatic compound bearing acid groups and/or salts thereof, water and any polar aprotic solvent present.

The at least one polyaromatic compound bearing acid groups and/or salts thereof can originate from the dried formulation B or from the dried formulation B and the aqueous formulation A.

Particular preference is thus given to a formulation C comprising
(Ca) from 1 to 50% by weight, preferably from 5 to 40% by weight, particularly preferably from 10 to 35% by weight, very particularly preferably from 25 to 35% by weight, of at least one polyaromatic compound bearing acid groups,
(Cb) from 50 to 99% by weight, preferably from 60 to 95% by weight, particularly preferably from 65 to 90% by weight, very particularly preferably from 65 to 75% by weight, of water and
(Cc) if appropriate, additionally from 0.1 to 5% by weight, preferably from 0.1 to 2% by weight, particularly preferably from 0.5 to 1% by weight, of at least one polar aprotic solvent selected from the group consisting of N-methyl-2-pyrrolidone, N,N-dimethylacetamide, dimethylformamide, dimethyl sulfoxide, tetrahydrofuran, acetonitrile, methylene chloride, chloroform, EtOAc and mixtures thereof, preferably N-methyl-2-pyrrolidone,
   with the sum of the dried formulation B, water and the at least one polar aprotic solvent which may be present if appropriate being 100% by weight.

Apart from aqueous formulations (formulations A and C) comprising at least one polyaromatic compound bearing acid groups and water and also, if appropriate, small amounts of a polar aprotic solvent, there is interest in water-comprising formulations D which comprise, in addition to any polar aprotic solvent which may already be present, at least one further polar aprotic solvent or an alcohol. Suitable polar aprotic solvents are, for example, NMP (N-methylpyrrolidone), DMAc (N,N-dimethylacetamide), DMF (dimethylformamide), DMSO (dimethyl sulfoxide), tetrahydrofuran, acetonitrile, methylene chloride, chloroform, EtOAc and also alcohols, e.g. methanol, ethanol, propanol, dialcohols such as ethylene glycol, trialcohols such as glycerol or mixtures thereof. The further polar aprotic solvent and the polar aprotic solvent which may be present in the aqueous formulation A can be identical or different. The ratio of water to the polar aprotic solvent and/or the alcohol in the water-comprising formulations D is generally from 50:1 to 1:5, preferably from 6:1 to 3:1.

The present invention therefore further provides water-comprising formulations D comprising
(Da) an aqueous formulation A as is obtained by means of step i) of the process of the invention or
   a formulation C as is obtained by addition of water or the formulation A of the invention to the dried formulation B and, in addition to any polar organic solvent already present in the aqueous formulation A or the formulation C,
(Db) at least 2% by weight, preferably from 2 to 30% by weight, particularly preferably from 5 to 25% by weight, very particularly preferably from 10 to 20% by weight, based on the total amount of the formulation, of at least one further polar aprotic solvent and/or at least one alcohol, with the total amount of the formulation being 100% by weight.

Suitable polar aprotic solvents and alcohols have been mentioned above. The proportion of the polar aprotic solvent and/or the alcohol in the water-comprising formulation is generally at least 2% by weight, preferably from 2 to 30% by weight, particularly preferably from 5 to 25% by weight, very particularly preferably from 10 to 20% by weight, based on the total amount of the water-comprising formulation.

The water-comprising formulation D of the invention is obtained by addition of at least 2% by weight, based on the total amount of the formulation, of at least one further polar aprotic solvent and/or at least one alcohol to the aqueous formulation A according to the invention as is obtained in step i) of the process of the invention or to the formulation C of the invention comprising the dried formulation B of the invention and water or the aqueous formulation A of the invention. Suitable polar aprotic solvents, suitable alcohols and suitable amounts of these solvents have been mentioned above.

The water-comprising formulations D of the invention cannot be produced by dissolving polyaromatic compounds bearing acid groups and/or salts thereof in a mixture of water and solvent because of the insolubility of the polyaromatic compounds bearing acid groups and/or salts thereof in water.

It has surprisingly been found that drying of a water-comprising formulation D according to the invention having a content of polar aprotic solvents and/or alcohols of ≧2% by weight gives a water-insoluble residue. The advantage of such a water-insoluble residue is that water-insoluble membranes comprising polyaromatic compounds bearing acid groups and/or salts thereof can be produced on the basis of the water-comprising formulations D of the invention. Such membranes are suitable, for example, for applications in fuel cells and electrolysis cells.

The water-comprising formulations D thus represent excellent casting solutions for producing water-insoluble membranes.

In production of a membrane starting out from the water-comprising formulations D of the invention, it is possible to carry out more rapid drying at lower temperatures since the boiling point of water is significantly lower than the boiling point of the organic solvents which are used in membrane production starting out from polyaromatic compounds bearing acid groups according to the prior art. Furthermore, the water-comprising formulations of the invention have a low viscosity, which aids filtration in membrane production. In addition, it is possible to achieve higher solids contents when using the water-comprising formulations D of the invention.

The present invention therefore further provides a process for producing a dry formulation E comprising at least one polyaromatic compound bearing acid groups and/or salts thereof by drying the water-comprising formulation D of the invention.

Suitable drying processes are known to those skilled in the art; for example, drying can be carried out at elevated temperatures.

After drying, dry formulations E which generally have a solids content of 70% by weight, preferably from 70 to 90% by weight, are obtained.

The present invention further provides a dry formulation E produced by the abovementioned process of the invention.

As mentioned above, the dry formulation E which is produced from a water-comprising formulation D having a content of polar aprotic solvent and/or alcohol of at least 2% by weight has the advantage that it is insoluble in water and can thus be used for producing membranes for fuel cells and electrolysis cells. Advantages resulting from the water-comprising formulation D in membrane production have been mentioned above.

It is thus possible to produce water-insoluble membranes starting out from the water-comprising formulation D, i.e. the water-comprising formulation D is, in a preferred embodiment, used as casting solution for membrane production.

The dry formulation E can additionally comprise at least one further polymer and/or further inorganic and/or organic compounds which can be solid or liquid, and these can be added before or after drying of the water-comprising formulation D. This means that the water-comprising formulation D can likewise additionally comprise at least one further polymer and/or further inorganic and/or organic compounds which can be solid or liquid. The additional presence of at least one further polymer in the water-comprising formulations D is of particular interest for the production of blend membranes. Furthermore, mixing of the dry formulation E with the further polymer and/or the inorganic and/or organic compounds is also conceivable. It is likewise conceivable for the further polymers to be deposited in the form of a film on a membrane which has been produced from the water-comprising formulation D.

Suitable further polymers are, for example, water-soluble or water-dispersible polymers such as polyvinylpyrrolidone and polyvinylcaprolactam.

The present invention therefore further provides dry formulations E which additionally comprise at least one further polymer, preferably at least one water-soluble or water-dispersible polymer such as polyvinylpyrrolidone and/or polyvinylcaprolactam and also, if appropriate, further inorganic and/or organic compounds.

The weight ratio of the at least one polyaryl ether ketone of the dry formulation to the at least one further polymer is generally from 1:99 to 99:1, preferably from 2:1 to 20:1.

The inorganic and/or organic compounds suitable as further constituents are generally low molecular weight or polymeric solids which may, for example, be able to take up or release protons.

Examples of such compounds which are able to take up or release protons are:
Sheet silicates such as bentonites, montmorillonites, serpentine, calinite, talc, pyrophyllite, mica. Further details may be found in Hollemann-Wiberg, Lehrbuch der Anorganischen Chemie, 91st-100th edition, p. 771 ff (2001).
Aluminosilicates such as zeolites.
Water-insoluble organic carboxylic acids, for example those having from 5 to 30, preferably from 8 to 22, particularly preferably from 12 to 18, carbon atoms and a linear or branched alkyl radical, which may, if appropriate, have one or more further functional groups such as, in particular, hydroxyl groups, C—C double bonds or carbonyl groups. The following carboxylic acids may be mentioned by way of example: valeric acid, isovaleric acid, 2-methylbutyric acid, pivalic acid, caproic acid, enanthic acid, caprylic acid, pelargonic acid, capric acid, undecanoic acid, lauric acid, tridecanoic acid, myristic acid, pentadecanoic acid, palmitic acid, margaric acid, stearic acid, nonadecanoic acid, arachic acid, behenic acid, lignoceric acid, cerotinic acid, melissic acid, tubercolostearic acid, palmitoleic acid, oleic acid, erucic acid, sorbic acid, linoleic acid, linolenic acid, elaeostearic acid, arachidonic acid, culpanodonic acid and docosahexanoic acid or mixtures of two or more thereof.
Polyphosphoric acids as are described, for example, in Hollemann-Wiberg, loc. cit., p. 659 ff.
Mixtures of two or more of the abovementioned solids.

It is likewise possible to add a further, preferably nonfunctionalized polymer. For the purposes of the present invention, the term “nonfunctionalized polymer” refers to polymers which are neither perfluorinated and sulfonated (ionomeric) polymers such as Nafion® or Flemion® nor polymers which are functionalized with groups suitable for obtaining a sufficient proton conductivity, for example —SO₃H groups or —COOH groups. These nonfunctionalized polymers which can be used for the purposes of the present invention are not subject to any particular restrictions as long as they are stable in the applications in which the polymer systems according to the invention are used. If these are, as per a preferred use, used in fuel cells, polymers which are thermally stable up to 100° C. and preferably up to 200° C. or higher and have a very high chemical stability should be used. Preference is given to using the following:
Polymers having an aromatic backbone, for example polyimides, polysulfones, polyether sulfones such as Ultrason®, polybenzimidazoles.
Polymers having a fluorinated backbone, for example Teflon® or PVDF.
Thermoplastic polymers or copolymers, for example polycarbonates such as polyethylene carbonate, polypropylene carbonate, polybutadiene carbonate or polyvinylidene carbonate or polyurethanes as are described, inter alia, in WO 98/44576.
Crosslinked polyvinyl alcohols.
Vinylpolymers such as
   polymers and copolymers of styrene or methylstyrene, vinyl chloride, acrylonitrile, methacrylonitrile, N-methylpyrrolidone, N-vinylimidazol, vinyl acetate, vinylidene fluoride.
   Copolymers of vinyl chloride and vinylidene chloride, vinyl chloride and acrylonitrile, vinylidene fluoride and hexafluoropropylene.
   Terpolymers of vinylidene fluoride and hexafluoropropylene and also a compound from the group consisting of vinyl fluoride, tetrafluoroethylene and trifluoroethylene.
Such polymers are disclosed, for example, in U.S. Pat. No. 5,540,741, whose relevant disclosure content is fully incorporated into the present patent application.
Phenol-formaldehyde resins, polytrifluorostyrene, poly-2,6-diphenyl-1,4-phenylene oxide, polyaryl ether sulfones, polyarylene ether sulfones, phosphonated poly-2,6-dimethyl-1,4-phenylene oxide.
Homopolymers, block copolymers and random copolymers prepared from:
   olefinic hydrocarbons such as ethylene, propylene, butylene, isobutene, propene, hexene or higher homologues, butadiene, cyclopentene, cyclohexene, norbornene, vinylcyclohexane.
   Acrylic or methacrylic esters such as methyl, ethyl, propyl, isopropyl, butyl, isobutyl, hexyl, octyl, decyl, dodecyl, 2-ethylhexyl, cyclohexyl, benzyl, trifluoromethyl or hexafluoropropyl esters or tetrafluoropropyl acrylate or tetrafluoropropyl methacrylate.
   Vinyl ethers such as methyl, ethyl, propyl, isopropyl, butyl, isobutyl, hexyl, octyl, decyl, dodecyl, 2-ethylhexyl, cyclohexyl, benzyl, trifluoromethyl or hexafluoropropyl or tetrafluoropropyl vinyl ether.

All of these nonfunctionalized polymers can in principle be used in crosslinked or uncrosslinked form.

The formulations of the invention are suitable for numerous applications known to those skilled in the art. An important aspect is that the process of the invention makes it possible to obtain formulations which can be used as ion-exchanging polymer systems in, for example, fuel cells, for example as ionomer or polymer electrolyte membrane, for example in membrane-electrode assemblies (MEAs).

The present invention therefore further provides for the use of a dry formulation E according to the invention as ionomer or polymer electrolyte membrane and also ionomers or polymer electrolyte membranes produced from the dry formulation E of the invention or the water-comprising formulation D of the invention. It is likewise possible to use the formulations A, B, C and D of the invention for producing ionomer formulations or polymer electrolyte membranes, if appropriate after further treatment of the formulations.

The polymer electrolyte membrane of the invention can be produced by essentially all suitable methods known to those skilled in the art. The production of the polymer electrolyte membrane of the invention is preferably carried out by producing a casting solution or casting dispersion comprising at least one polyaromatic compound bearing acid groups and/or salts thereof. The casting solution or casting dispersion can be the water-comprising formulation D of the invention or the dry formulation E of the invention dissolved in at least one of the abovementioned polar aprotic solvents and/or alcohols. The casting solution or casting dispersion is applied to a suitable support, for example by spreading out the casting solution or dispersion by means of a doctor blade. Suitable supports are, for example, a glass plate or PET film. It is also possible, for example, to apply the casting solution or casting dispersion to, should this be necessary, a support material by dipping, spin coating, roller coating, spray coating, printing and letterpress, gravure, flatbed or screen printing processes or else by extrusion. The further processing can be carried out in a customary way, for example by removal of the solvent or the mixture of water with a suitable solvent by drying at room temperature or elevated temperature, if appropriate under reduced pressure. It is likewise possible to produce polymer electrolyte membranes by evaporating the solvent or mixture of solvent and water to a solids concentration of from 50 to 99% by weight by methods known to those skilled in the art and subsequently precipitating the membrane by methods known to those skilled in the art using a precipitant which is miscible with the solvent and water adhering to the membrane. The membrane is subsequently freed of the solvent or the mixture of solvent and water in a manner known to those skilled in the art. Processes for producing electrolyte membranes are known to those skilled in the art and are disclosed, for example, in EP-A 0 574 791, DE-A 42 11 266 and DE-A 34 02 471.

Before use, the polymer electrolyte membranes of the invention are generally washed with any inorganic and/or organic acids (activation) using methods known to those skilled in the art. Here, any salts of sulfonic acids present in the membrane are converted into the free sulfonic acids and any residual solvent present is washed out.

Preference is given to producing polymer electrolyte membranes which have a thickness of from 5 to 500 μm, preferably from 10 to 500 μm and particularly preferably from 10 to 200 μm (thickness of the dry polymer electrolyte membrane).

The present invention further provides a composite comprising at least one first layer comprising at least one polyaromatic compound bearing acid groups in the form of a dry formulation E according to the invention, with any salts of sulfonic acids present in the formulation according to the invention being converted into the free sulfonic acids either before or after production of the composite, in general by washing with any inorganic and/or organic acids, and also such a composite which comprises at least one first layer comprising at least one polyaromatic compound bearing acid groups in the form of a dry formulation according to the invention in the form of a membrane and additionally at least one electrically conductive catalyst layer (catalyst coated membrane CCM). Suitable CCMs comprise a catalyst layer, e.g. made up of a polymer, preferably a dry formulation E, carbon black and a catalyst, preferably a noble metal catalyst or a catalyst layer produced by application of catalyst ink to the membrane. Suitable catalyst inks comprise, for example, agglomerates of catalytically active noble metals (e.g. catalytic platinum or ruthenium agglomerates) and at least one solvent. Suitable solvents are water, alcohols (monohydric or polyhydric alcohols, e.g. alcohols having 1, 2 or 3OH groups), DMAc (N,N-dimethylacetamide), DMF (dimethylformamide), DMSO (dimethyl sulfoxide) or NMP (N-methylpyrrolidone). Preferred catalyst inks are the aqueous catalyst formulations mentioned below. The catalyst inks can, for example, be applied to the membrane by spraying, doctor blade coating or printing and also further methods known to those skilled in the art.

The composite can further comprise, in addition to the membrane and the catalyst layer or layers, one or more gas diffusion layers (GDLs), e.g. a carbon nonwoven. The catalyst layer(s) is (are) located on the gas diffusion layer(s) so as to give a membrane-electrode assembly (MEA).

Suitable membrane-electrode assemblies and catalyst coated membranes and also their production are known to those skilled in the art.

A suitable MEA is produced, for example, by applying a catalyst ink to a GDL to give a coated GDL. Two coated GDLs are subsequently processed together with a polymer electrolyte membrane arranged between the GDLs to produce an MEA, e.g. by means of a hot pressing process. Preferred catalyst inks and polymer electrolyte membranes are the catalyst inks and polymer electrolyte membranes of the invention. Suitable processes for producing the MEA are known to those skilled in the art.

This composite can further comprise one or more bipolar electrodes.

The present invention further provides a fuel cell comprising at least one polymer electrolyte membrane according to the invention or a composite according to the invention.

Preferred polyaromatic compounds bearing acid groups have been mentioned above.

Furthermore, the aqueous and water-comprising formulations of the invention can be used according to the present invention for producing catalyst formulations (polymer electrolyte+carbon black+noble metal catalyst, water and, if appropriate, solvent, preferably a water-miscible solvent) and for applying polyaromatic compounds bearing acid groups to membranes and gas diffusion electrodes. An advantage of the formulations of the invention is that, due to their altered polymer morphology, they make a higher degree of utilization of the noble metal catalyst possible. As a result, a lower loading of the catalyst with noble metal than in the prior art is possible and the production of the noble metal catalysts is thus cheaper. Furthermore, the partial dissolution of the membrane to achieve better contact between the membrane and the catalyst layer can be controlled in a targeted manner when using the water-comprising formulations of the present invention. In addition, the abovementioned aqueous or water-comprising catalyst formulations (catalyst inks) have a low flammability, which makes handling of the pyrophoric catalyst easier.

To achieve uniform distribution of the particles in the catalyst ink, it is necessary to use high-boiling solvents and/or dispersants in the production of catalyst inks according to the prior art, e.g. EP-A 1 503 439. The use of dispersants is not necessary in the production of the catalyst inks according to the invention. Furthermore, the presence of high-boiling solvents can be avoided or their proportion can at least be greatly reduced in the catalyst inks according to the invention.

The following examples illustrate the invention.

### EXAMPLES

### Example 1

Treatment of a polyaromatic compound bearing acid groups (H form) at 180° C.

20 g of dry sPEEK (content of acid groups (AG): 42%) are admixed with 180 g of water and treated at 180° C. in an autoclave for 30 minutes. The gel-like solid formed is separated off from the solution by centrifugation and is subsequently dried. Gel yield: 2.6 g (13%).

### Example 2

Treatment of a polyaromatic compound bearing acid groups (H form) which has a residual moisture content of 77% by weight at 180° C.

100 g of moist sPEEK (AG: 42%, water content: 77%) are admixed with 120 g of water and treated at 180° C. in an autoclave for 30 minutes. The gel-like solid formed is separated off from the solution by centrifugation and is subsequently dried. Gel yield: 0.92 g (4%).

### Example 3

Treatment of a polyaromatic compound bearing salts of acid groups which has a residual moisture content of 77% by weight at 180° C.

3.1 Preparation of sPEEK-Na Having a Residual Moisture Content of 77% by Weight

500 g of moist sPEEK (AG: 42%, water content: 77%) are admixed with an excess of aqueous NaOH solution in a glass beaker and stirred at room temperature for 30 minutes. The solid is subsequently separated off from the solution by means of filtration and washed with distilled water until the washings have a pH of 5-6.

3.2 Treatment of the Moist sPEEK-Na Obtained in Example 3.1

100 g of moist sPEEK-Na (AG: 42%, water content: 77%) are admixed with 120 g of water and treated at 180° C. in an autoclave for 30 minutes. The gel-like solid formed is separated off from the solution by centrifugation and is subsequently dried. Gel yield: 0.21 g (0.9%).

### Example 4

Treatment of a polyaromatic compound bearing free acid groups or salts of acid groups which has a residual moisture content of 75% by weight at 180° C. in the absence and in the presence of a polar aprotic solvent

All examples are autoclaved at a solids content (SC) of 10%; the SC of the finished casting solution varies from 25% in the case of H-sPEEK to 30% in the case of Na-sPEEK

4.1 Treatment of Moist sPEEK

### 4.1.1 Treatment in the Absence of a Polar Aprotic Solvent

100 g of moist sPEEK (AG=43.0%, SC=25%) are treated with 150 g of water at 180° C. in an autoclave for 30 minutes. The solution is filtered and dried.

25 g of the powder formed are then dissolved in 15 g of NMP and 60 g of water and the viscosity is measured at RT. It is 100 mPas.

### 4.1.2 Treatment in the Presence of a Polar Aprotic Solvent

100 g of moist sPEEK (AG=43.0%, SC=25%) are treated with 147.5 g of water and 2.5 g of NMP (1% by weight) at 180° C. in an autoclave for 30 minutes. The solution is filtered and dried.

25 g of the powder formed are then dissolved in 15 g of NMP and 60 g of water and the viscosity is measured at RT. It is 65 mPas.

4.2 Treatment of Moist sPEEK-Na

### 4.2.1 Treatment in the Absence of a Polar Aprotic Solvent

100 g of moist sPEEK-Na (AG=43.0%, SC=25%) are treated with 150 g of water at 180° C. in an autoclave for 30 minutes. The solution is filtered and dried.

30 g of the powder formed are then dissolved in 15 g of NMP and 55 g of water and the viscosity is measured at RT. It is 290 Pas.

### 4.2.2 Treatment in the Presence of a Polar Aprotic Solvent

100 g of moist sPEEK-Na (AG=43.0%, SC=25%) are treated with 147.5 g of water and 2.5 g (1% by weight) of NMP at 180° C. in an autoclave for 30 minutes. The solution is filtered and dried.

30 g of the powder formed are then dissolved in 15 g of NMP and 55 g of water and the viscosity is measured at RT. It is 105 mPas.

1-24. (canceled)

25. A process for producing a formulation comprising at least one polyaromatic compound bearing acid groups and/or salts of acid groups, which comprises
(i) treatment of a mixture comprising at least one polyaromatic compound bearing acid groups and/or salts of acid groups and water at a temperature of >170° C. in a closed reactor to give an aqueous formulation A,
comprising
(Aa) from 1 to 30% by weight of at least one polyaromatic compound bearing acid groups and/or salts of acid groups,
(Ab) from 70 to 99% by weight of water and
(Ac) optimally from 0.1 to 5% by weight of at least one polar aprotic solvent selected from the group consisting of N-methyl-2-pyrrolidone, dimethylformamide, N,N-dimethylacetamide, dimethyl sulfoxide, tetrahydrofuran, acetonitrile, methylene chloride, chloroform, EtOAc and mixtures thereof,
with the sum of the at least one polyaromatic compound bearing acid groups and/or salts of acid groups, water and the at least one polar aprotic solvent which optionally may be present being 100% by weight.

26. The process according to claim 25, wherein the polyaromatic compound bearing acid groups and/or salts of acid groups is selected from the group consisting of polyaryl ether ketones, polyaryl sulfones, polyether sulfones, polyphenylene sulfides and polysulfones bearing sulfonic acid, phosphoric acid, carboxyl groups and boric acid groups and salts thereof.

27. The process according to claim 25, wherein the polyaromatic compounds bearing salts of acid groups are salts having monovalent cations.

28. The process according to claim 25, wherein the sum of the acid groups and salts of acid groups in the polyaromatic compounds is from 0.5 to 2 mmol per g of polyaromatic compound.

29. The process according to claim 25, wherein the at least one polyaromatic compound bearing acid groups and/or salts of acid groups has a residual moisture content of ≧30% by weight.

30. The process according to claim 29, wherein the at least one polyaromatic compound bearing acid groups end/or salts of acid groups does not have a residual moisture content of less than 30% by weight at any point of time during its preparation.

31. An aqueous formulation A produced by a process according to claim 25, comprising
(Aa) from 1 to 30% by weight of at least one polyaromatic compound bearing acid groups and/or salts of acid groups,
(Ab) from 70 to 99% by weight of water and
(Ac) optionally from 0.1 to 5% by weight of at least one polar aprotic solvent selected from the group consisting of N-methyl-2-pyrrolidone, dimethylformamide, N,N-dimethylacetamide, dimethyl sulfoxide, tetrahydrofuran, acetonitrile, methylene chloride, chloroform, EtOAc and mixtures thereof,
with the sum of the at least one polyaromatic compound bearing acid groups and/or salts of acid groups, water and the at least one polar aprotic solvent which optionally may be present being 100%, by weight.

32. The process according to claim 25 which additionally comprises:
(ii) removal of the water from the aqueous formulation A obtained in (i) to give a dried formulation B.

33. A dried formulation B produced by a process according to claim 32.

34. A formulation C, comprising
a) a dried formulation B according to claim 33 and
b) water or an aqueous formulation A comprising
(Aa) from 1 to 30% by weight of at least one polyaromatic compound bearing acid groups and/or salts of acid groups,
(Ab) from 70 to 99% by weight of water and
(Ac) optimally from 0.1 to 5% by weight of at least one polar aprotic solvent selected from the group consisting of N-methyl-2-pyrrolidone, dimethylformamide, N,N-dimethylacetamide, dimethyl sulfoxide, tetrahydrofuran, acetonitrile, methylene chloride, chloroform, EtOAc and mixtures thereof,
with the sum of the at least one polyaromatic compound bearing acid groups and/or salts of acid groups, water and the at least one polar aprotic solvent which optionally may be present being 100% by weight.

35. The formulation C according to claim 34 comprising
(Ca) from 1 to 50% by weigh, of at least one polyaromatic compound bearing acid groups and/or salts of acid groups,
(Cb) from 50 to 99% by weight of water and
(Cc) optionally from 0.1 to 5% by weight of at least one polar aprotic solvent selected from the group consisting of N-methyl-2-pyrrolidone, N,N-dimethylacetamide, dimethylformamide, dimethyl sulfoxide, tetrahydrofuran, acetonitrile, methylene chloride, chloroform, EtOAc and mixtures thereof
with the sum of the dried formulation B, water and the at least one polar aprotic solvent which optionally may be present being 100% by weight.

36. A water-containing formulation D, comprising
(Da) an aqueous formulation A according to claim 31 or a formulation C comprising
a) a dried formulation B produced by the removal of the water from the aqueous formulation A and
b) water or an aqueous formulation A comprising
(Aa) from 1 to 30% by weight of at least one polyaromatic compound bearing acid groups and/or salts of acid groups,
(Ab) from 70 to 99% by weight of water and
(Ac) optimally from 0.1 to 5% by weight of at least one polar aprotic solvent selected from the group consisting of N-methyl-2-pyrrolidone, dimethylformamide, N,N-dimethylacetamide, dimethyl sulfoxide, tetrahydrofuran, acetonitrile, methylene chloride, chloroform, EtOAc and mixtures thereof,
with the sum of the at least one polyaromatic compound bearing acid groups and/or salts of acid groups, water and the at least one polar aprotic solvent which optionally may be present being 100% by weight and, in addition to any polar organic solvent already present in the aqueous formulation A or the formulation C, and
(Db) at least 2% by weight, based on the total amount of the formulation, of at least one additional polar aprotic solvent and/or at least one alcohol.

37. The water-containing formulation D according to claim 36, wherein the additional polar aprotic solvent is selected from the group consisting of N-methyl-2-pyrrolidone, N,N-dimethylacetamide, dimethylformamide, dimethyl sulfoxide, tetrahydrofuran, acetonitrile, methylene chloride, chloroform, EtOAc, methanol, ethanol, propanol, ethylene glycol, glycerol and mixtures thereof, with the additional polar aprotic solvent and the polar aprotic solvent which may be present in the aqueous formulation A or the formulation C being identical or different.

38. A process for producing a water-containing formulation D according to claim 36 by addition of at least 2% by weight, based on the total amount of the formulation, of at least one polar aprotic solvent and/or at least one alcohol to an aqueous formulation A comprising
(Aa) from 1 to 30% by weight of at least one polyaromatic compound bearing acid groups and/or salts of acid groups,
(Ab) from 70 to 99% by weight of water and
(Ac) optionally from 0.1 to 5% by weight of at least one polar aprotic solvent selected from the group consisting of N-methyl-2-pyrrolidone, dimethylformamide, N,N-dimethylacetamide, dimethyl sulfoxide, tetrahydrofuran, acetonitrile, methylene chloride, chloroform, EtOAc and mixtures thereof,
with the sum of the at least one polyaromatic compound bearing acid groups and/or salts of acid groups, water and the at least one polar aprotic solvent which optionally may be present being 100%, by weight or addition of at least 2% by weight, based on the total amount of the formulation D, of at least one polar aprotic solvent and/or at least one alcohol to a formulation C comprising
a) a dried formulation according to claim 33 and
b) water or an aqueous formulation A comprising
(Aa) from 1 to 30% by weight of at least one polyaromatic compound bearing acid groups and/or salts of acid groups,
(Ab) from 70 to 99% by weight of water and
(Ac) optimally from 0.1 to 5% by weight of at least one polar aprotic solvent selected from the group consisting of N-methyl-2-pyrrolidone, dimethylformamide, N,N-dimethylacetamide, dimethyl sulfoxide, tetrahydrofuran, acetonitrile, methylene chloride, chloroform, EtOAc and mixtures thereof,
with the sum of the at least one polyaromatic compound bearing acid groups and/or salts of acid groups, water and the at least one polar aprotic solvent which optionally may be present being 100% by weight.

39. A process for producing a dry formulation E comprising at least one polyaromatic compound bearing acid groups and/or salts of acid groups by drying the water-containing formulation D according to claim 36.

40. A dry formulation E produced by a process according to claim 39.

41. The dry formulation E according to claim 40 which additionally comprises at least one additional polymer.

42. A polymer electrolyte membrane produced from a water-containing formulation D according to claim 36.

43. A composite comprising at, least one first layer comprising at least one polyaromatic compound bearing acid groups and/or salts of acid groups in the form of a dry formulation E according to claim 40 in the form of a membrane and additionally at least one electrically conductive catalyst layer.

44. A composite comprising at least one first layer comprising at least one polyaromatic compound bearing acid groups and/or salts of acid groups in the form of a dry formulation E according to claim 40 in the form of a membrane and additionally at least one electrically conductive catalyst layer and one or more gas diffusion layers, with the catalyst layer(s) being located on the gas diffusion layer(s).

45. A fuel cell comprising at least one polymer electrolyte membrane according to claim 42.

46. A fuel cell comprising at least one composite according to claim 43.
